(19) United States
(12) Patent Application Publication
(10) Pub. No.: US 2018/0274438 A1
(43) Pub. Date: Sep. 27, 2018

(54) Gasoline Engine with Glow Plug Heater for a Model Car

(71) Applicant: GOLDEN LION ENTERPRISE CO., LTD., TAICHUNG (TW)

(72) Inventor: Lien-Sheng CHANG, TAICHUNG (TW)

(21) Appl. No.: 15/465,243

(22) Filed: Mar. 21, 2017

(51) Int. Cl. F02B 75/34; F02B 23/02; F02P 19/02

(52) U.S. Cl. CPC F02B 75/34; F02P 19/02; F02B 23/02

(57) ABSTRACT

A gasoline engine for a model car comprises a cylinder having a combustion chamber formed therein, a connecting seat positioned on the cylinder having a threaded bore in communication with the combustion chamber, a glow plug having a heater equipped therein and installed in the threaded bore of the connecting seat and a preheating net having a circular frame adapted to form in the connecting seat. The preheating net will maintain its temperature to preheat the injected mixture of gasoline and air which will be combusted completely to increase the efficiency of the gasoline engine.

### BACKGROUND OF THE INVENTION

### Field of the Invention

The present invention relates to a gasoline engine for a model car, particularly a gasoline engine with a glow plug heater.

### Brief Description of the Prior Art

Conventional model car uses a gasoline engine equipped with a capacitor discharge ignition (CDI) system to ignite the mixture of gasoline and air. The efficiency of the gasoline engine is relatively poor because it always takes a longer time to get ignited to operate smoothly. Also, the CDI system generally includes a relatively complicated electrical circuitry which causes the model car having difficulty in maintenance.

In order to improve the efficiency of the gasoline engine of a model car, a glow plug having a heater has been adapted to replace the CDI system. A perspective exploded view of a conventional model car gasoline engine with a glow plug is shown in FIG. 1. The engine has a cylinder 1 having a combustion chamber 2 formed in it. A seat 3 is covered on the cylinder 1 with a gasket 7 equipped between them. The seat 3 has an inner thread 8 formed to be connected to the outer thread 9 of a glow plug 4. A washer 5 is sleeved on the glow plug 4 and then installed on the seat 3. A heat sink 6 is installed on the cylinder 1 to dissipate the heat resulted from the cylinder 1 during combustion. There is a heater, which is not shown in FIG. 1, formed in the glow plug 4. The heater in the glow plug 4 will be heated during the operation of the gasoline engine and will continuously add heat to the injected mixture of gasoline and air.

This improved gasoline engine still has two important disadvantages. The mixture of gasoline and air, during its injection into the cylinder, may pass the heater in the glow plug 4 resulting a lower temperature of the same. Then the combustion in the cylinder may not complete and the operation efficiency becomes poor. Because the glow plug 4 is installed on the seat 3 through inner thread 8 and outer thread 9, there will be vibration between them because of the not very tight contact between the threads. The pressure leakage between the threads will cause absorption of the engine power and in turn reduce the operation efficiency of the gasoline engine.

### SUMMARY OF THE INVENTION

The principal object of the present invention is to provide a gasoline engine for a model car with a function of preheating the injected mixture of gasoline and air for a complete combustion.

Another object of the present invention is to provide a gasoline engine for a model car using a glow plug having a heater equipped therein.

An important feature of the present invention is to provide a connecting seat formed with a conical bore and a glow plug has a conical portion formed at its one end which will be closely fitted in the conical bore of the connecting seat.

Still another feature of the present invention is to provide a preheating net having a circular frame to be installed in a conical bore of the connecting seat.

Still another feature of the present invention is to provide a preheating net having a plurality of ribs extending from the circular frame to form a central plate positioned beneath the heater of the glow plug.

Therefore, the gasoline engine for a model car comprises a cylinder having a combustion chamber formed therein, a connecting seat positioned on the cylinder having a threaded bore in communication with the combustion chamber, a glow plug having a heater equipped therein to be installed in the threaded bore of the connecting seat and a preheating net having a circular frame adapted to form in the connecting seat. The connecting seat is formed with a conical bore which is inserted haby the glow plug and fitted tightly with the conical bore of the connecting seat. The preheating net has a circular frame adapted to form in the connecting seat. The preheating net will maintain its temperature to preheat the injected mixture of gasoline and air which will be combusted completely to increase the efficiency of the gasoline engine.

### BRIEF DESCRIPTION OF THE DRAWINGS

Those and other advantage, object and features of the gasoline engine for a model car in accordance with the present invention will become more apparent from the below detailed description of the preferred embodiment with reference to the accompanying drawings, wherein:

FIG. 1 is a perspective exploded view of a conventional model car gasoline engine with a glow plug;

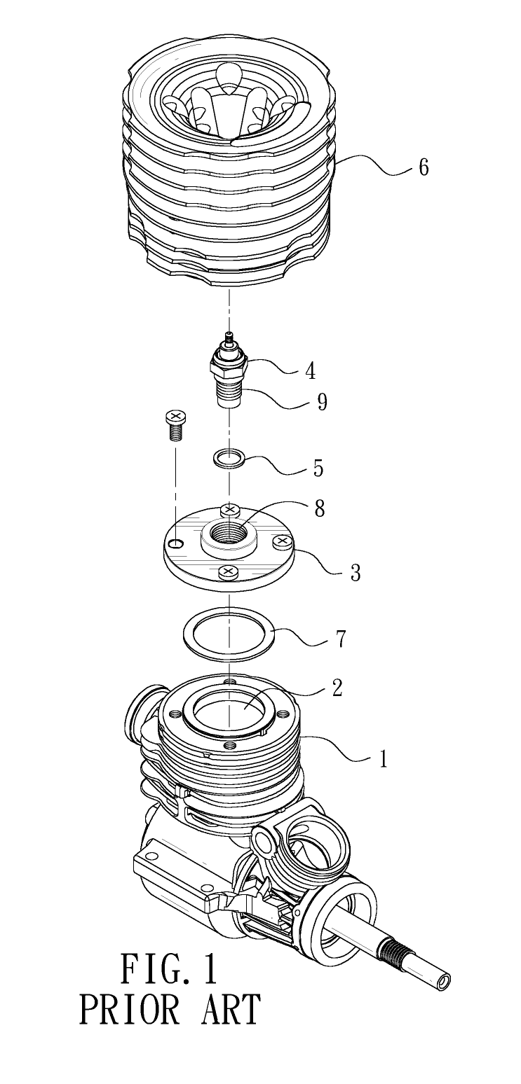

FIG. 2 is a perspective exploded view of a model car gasoline engine having a glow plug in accordance with an embodiment of the present invention;

FIG. 3 is a perspective exploded view of a connecting seat having a preheating net equipped thereon of a model car gasoline engine with a glow plug in accordance with an embodiment of the present invention;

FIG. 4 is a sectional view of a preheating net used in a gasoline engine of a model car in accordance with the embodiment of the present invention; and

FIG. 5 is a partial sectional view of a gasoline engine of a model car in accordance with the embodiment of the present invention.

### DETAILED DESCRIPTION OF THE PREFERRED EMBODIMENT

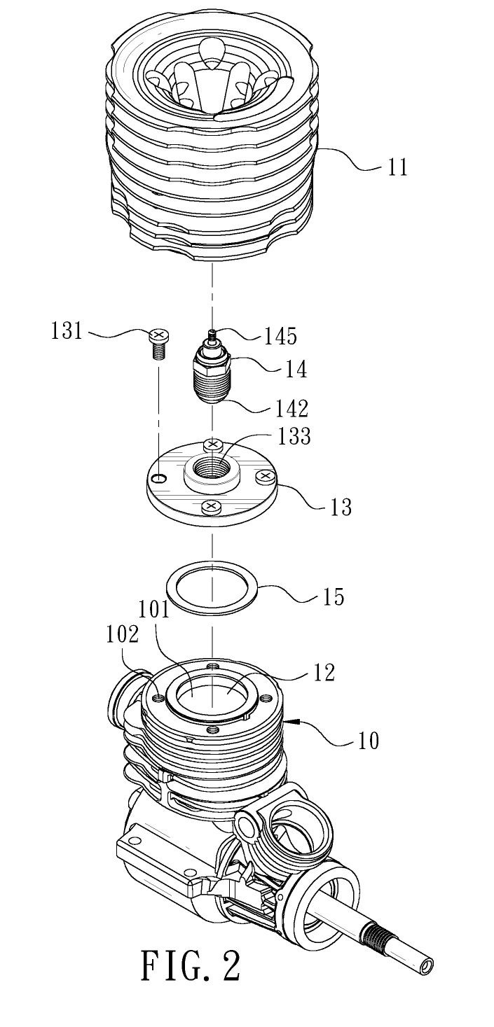

Referring to FIG. 2 which shows a perspective exploded view of a model car gasoline engine with a glow plug in accordance with an embodiment of the present invention, the gasoline engine 10 has a cylinder 10 with a combustion chamber 12 formed therein and an opening 101. A plurality of screw holes 102 are formed at the peripheral upper surface of the cylinder 10. A connecting seat 13 is generally in the shape of a circular plate which will be fastened to the cylinder 10 with a plurality of screws 131. There is a washer 15 installed between the connecting seat 13 and the cylinder 10. The connecting seat 13 has a threaded bore 133 for a glow plug 14 to be fitted therein. The glow plug 14 is generally in a cylinder shape with its lower portion formed into a conical portion 142. At one end of the glow plug 14, there is equipped with an electrode 145 for heating a preheating net and a heater installed in the glow plug 14 to be more clearly described herein below. A heat sink 11 substantially in the shape of a sleeve is covered onto the gasoline engine 10.

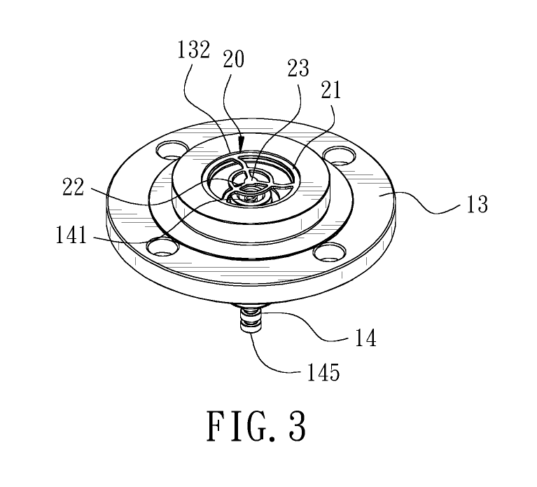

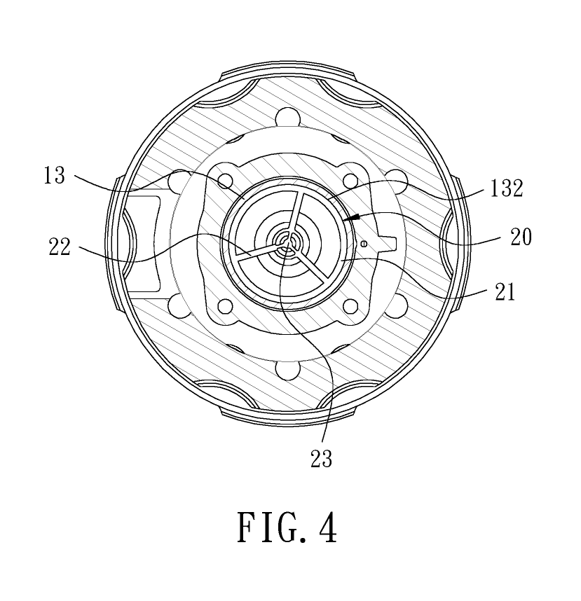

In the connecting seat 13, there is installed a prehearing net 20. The construction and function of the preheating net can be seen and described as the same shown in FIG. 3 and FIG. 4 which are perspective exploded view and sectional view of a model car gasoline engine with a glow plug in accordance with an embodiment of the present invention. The preheating net 20 is made of a metal material which is preferably a nickel alloy in the present embodiment. The preheating net 20 is substantially in a circular shape to be fitted in a circular recess 132 of the connecting seat 13. The preheating net 20 comprises a circular frame 21 which comprises a plurality of ribs 22 extending therefrom and toward the center of the preheating net 20 to form a central plate 23. The central plate 23 is in a dimension suitably to shield the heater 141 of the glow plug 14. It is readily understood that the preheating net 20 can be integrally molded with the connecting seat 13.

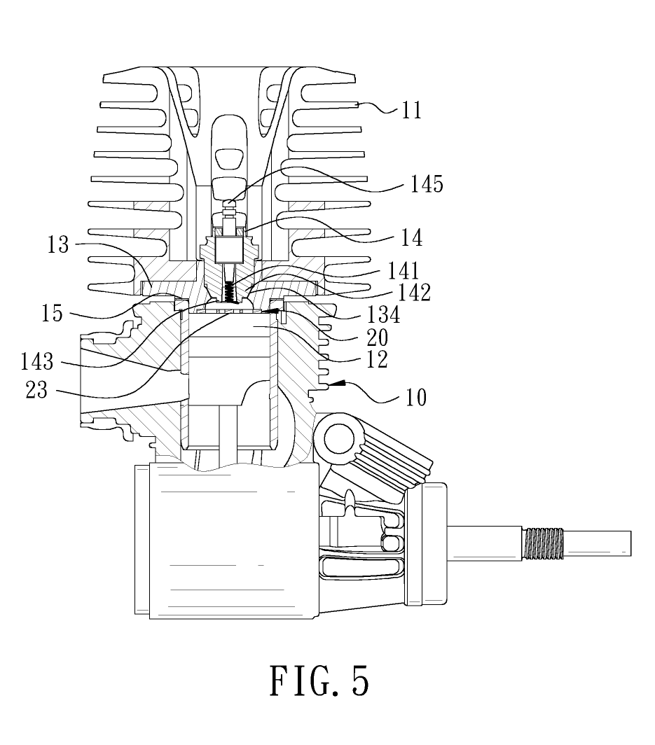

The structure of the preheating net 20 and the glow plug 14 can be better understood in view of FIG. 5 which is a partial sectional view of a gasoline engine of a model car in accordance with the embodiment of the present invention. In FIG. 5, the glow plug 14 has a heater 141 equipped therein to be preheated by the electricity energy from the electrode 145. The glow plug 14 is substantially in the shape of a cylinder with its lower end formed into a conical portion 142 to communicate with the combustion chamber 12 of the cylinder 10 with a shrinkage cavity 143. The connecting seat 13 is formed with a conical bore 134 which is inserted by the glow plug 14. The conical portion 142 of the glow plug 14 is fitted tightly with the conical bore 134 of the connecting seat 13. The preheating net 20 is mounted on the peripheral surface of the cylinder 10 with a washer 15 and communicating with the combustion chamber 12. The central plate 23 of the preheating net 20 is positioned right under the heater 141 of the glow plug 14.

It is noted that the conical portion 142 is tightly in touch with the conical bore 134 of the connecting seat 13. The pressure in the combustion chamber 20 of the cylinder 10 will be sustained during the combustion of the mixture of gasoline and air. It is also noted that the central plate 23 of the preheating net 20 is positioned beneath the heater 141 of the glow plug 14. The mixture of gasoline and air in the combustion chamber 12 in a relatively low temperature will not directly spray on the heater 141. The preheating net 20 will maintain its temperature to preheat the injected mixture. Therefore, the mixture can be combusted completely thus increase the efficiency of the gasoline engine of the model car.

Although the gasoline engine, having a glow plug heater for a model car in accordance with the present invention, has been described by way of an embodiment, it is noted other changes, improvements and modifications can still be made without departing from the spirit and scope of the present invention.

What is claimed is:

1. A gasoline engine for a model car comprising:
a cylinder having a combustion chamber formed therein;
a connecting seat positioned on said cylinder having a threaded bore in communication with said combustion chamber;
a glow plug having a heater equipped therein and installed in said threaded bore of said connecting seat; and
a preheating net having a circular frame adapted to form in said connecting seat.

2. A gasoline engine for a model car as claimed in claim 1 wherein said preheating net further comprising a plurality of ribs extending from said circular frame.

3. A gasoline engine for a model car as claimed in claim 2 wherein said plurality of ribs extending toward the center of said preheating net to form a central plate right beneath said heater of said glow plug.

4. A gasoline engine for a model car as claimed in claim 1 wherein said glow plug further comprising a conical portion formed at one end thereof, and said connecting seat further comprising a conical bore to closely embrace said conical portion of said glow plug.

5. A gasoline engine for a model car as claimed in claim 1 said connecting seat further comprising a circular recess for the installation of said preheating net.

6. A gasoline engine for a model car as claimed in claim 1 wherein said preheating net is made of Nickel alloy.

7. A gasoline engine for a mold car as claimed in claim 1 wherein said preheating net can be integrally molded with the connecting seat.
